(19) United States
(12) Patent Application Publication
(10) Pub. No.: US 2018/0073596 A1
(43) Pub. Date: Mar. 15, 2018

(54) TURNBUCKLE WITH IMPROVED TOGGLE JAW

(71) Applicant: Edward J. Herman, Annapolis, MD (US)

(72) Inventor: Edward J. Herman, Annapolis, MD (US)

(21) Appl. No.: 15/525,249

(22) PCT Filed: Nov. 9, 2015
(86) PCT No.: PCT/US2015/059721

§ 371 Date: May 8, 2017

Related U.S. Application Data
(60) Provisional application No. 62/076,596, filed on Nov. 7, 2014.

(51) Int. Cl. F16G 11/12

(52) U.S. Cl. CPC F16G 11/12

(57) ABSTRACT

An improved turnbuckle (2) comprising an elongate barrel (10) having two ends, with counter-threaded apertures entering the two ends. A T-shaped stud (14) is threaded at one end and carries a cross-bar at the other end. The threaded end of the T-shaped stud (14) is screw-threaded into one end of the barrel. A toggle jaw (16) is mounted on the T-shaped stud 14). The toggle jaw (16) comprises a U-shaped yoke (19). A clevis pin (17) is inserted through the coaxial through-bores of the opposing flanges of the yoke (19), and an annular collar (36) is fitted overtop the protruding clevis pin (17), and a retaining pin (40) is inserted through both the collar (36) and clevis pin (17). This design eliminates rubbing or tearing of lines or sails, is stronger, and is better able to avoid loosening.

### CROSS-REFERENCE TO RELATED APPLICATIONS

### Continuity

This application claims priority to and the benefit of U.S. Provisional Patent Application No. 62/076,596 filed 7 Nov. 2014, which is incorporated herein in their entirety by reference.

### FIELD OF THE INVENTION

This invention relates generally to sailboat rigging and, more particularly, to an improved turnbuckle for sailboat rigging and other rigging applications.

### BACKGROUND OF THE INVENTION

Standing rigging on sailboats and yachts includes a network of ropes or cables used to stay the mast (e.g., “shrouds), which may be solid rods, wire cables or rope. These shrouds are connected to the vessel by turnbuckles.

A turnbuckle, stretching screw or bottle screw is a device for adjusting the tension or length of ropes, cables, tie rods, or the like. FIG. 1 is a side view of a conventional turnbuckle used for rigging, which generally comprises an elongate stainless steel barrel 10 having two ends, and opposing stud-mounted fixtures 12, 14 threaded into the ends of the barrel 10, one with a left-hand thread and the other with a right-hand thread. The tension can be adjusted by rotating the barrel 10, which causes both studs to be screwed in or out simultaneously, without twisting the attached cables. There are a wide variety of stud-mounted fixtures generally classified as barrels, forks, jaws, pin eyes and cable eyes. Fixture 12 illustrated is a barrel, while fixture 14 extends downward to a toggle jaw 16. Turnbuckles are prevalent in sailboat rigging but are also commonly used in any applications which require tension, including flight control systems, sports rigging (boxing rings and the like) and entertainment (stage) rigging.

The toggle jaw 16 of FIG. 1 comprises a yoke 19 pivotally mounted on a T-style fixture 14. The yoke 19 carries a clevis pin 17 which pin is typically secured therein by an enlarged head on one side and a cotter pin 18 on the other. This creates a problem. Especially in the case of sailboat rigging, the sails and shrouds tend to rub against the rigging hardware. Rubbing of lines or sails against sharp objects or sharp edges of turnbuckles can result in abrasive chafe or wear of the lines, sails and/or standing rigging. The cotter pins 18 are notorious for tearing sails. What is needed is a toggle jaw 16 that has absolutely no sharp edges or protrusions, and yet is strong or stronger than conventional designs.

### SUMMARY

It is, therefore, an object of the invention to provide a more robust turnbuckle having one or two toggle jaws with absolutely no sharp edges or protrusions.

It is another object to provide a turnbuckle as described above that is stronger and more reliable than conventional designs.

In accordance with the foregoing objects, the present invention is an improved turnbuckle comprising an elongate barrel having two ends, with counter-threaded apertures entering the two ends. A T-shaped stud is threaded at one end and carries a cross-bar at the other end. The threaded end of the T-shaped stud is screw-threaded into one end of the barrel. A toggle jaw is mounted on the T-shaped stud. The toggle jaw further comprises a yoke formed from a flat plate member bent in a U-shape cross-section and having a central slot therein. The cross-bar of the T-shaped stud seats within the U of the yoke with the stud passing outward through the central slot into the barrel. The U-shaped yoke extends to a pair of opposing flanges both having through-bores therein. A clevis pin is inserted through the coaxial through-bores of the opposing flanges of the yoke. The clevis pin is a smooth cylindrical member of uniform diameter along a majority of its length with a pronounced circular head at one end. The clevis pin is long enough to protrude outward (2-4 mm) through the flange of the yoke. This protruding section of the clevis pin is defined by an orthogonal through bore. An annular collar is fitted overtop the protruding section of the clevis pin and serves as both a bearing shoulder and retainer for the clevis pin. The collar likewise has a through bore through both walls, this through bore being internally threaded inside at least one of the walls. A retaining pin is inserted through both the collar and clevis pin. The retaining pin is screw-threaded at one end for anchoring it inside the collar via the threaded through bore therein. The retaining pin seats flush within the collar and completely eliminates rubbing or tearing of lines or sails. Moreover, the turn buckle is stronger than conventional designs, and is better able to avoid loosening and/or dislodgement of the clevis pin as a result of impact or vibration.

### DESCRIPTION OF THE FIGURES

The accompanying drawings, which are incorporated in and constitute a part of this specification, illustrate certain aspects of the instant invention and together with the description, serve to explain, without limitation, the principles of the invention. Like reference characters used therein indicate like parts throughout the several drawings.

FIG. 1 is a side view of a prior art turnbuckle used for rigging.

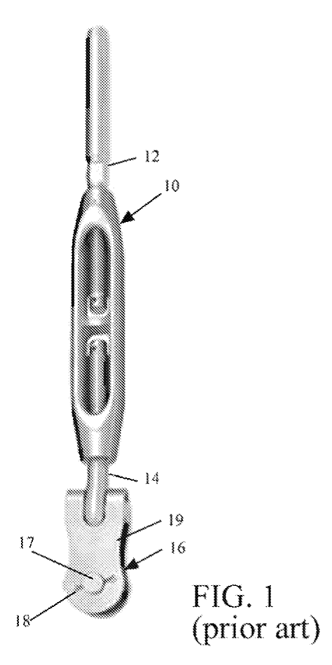

FIG. 2 is a perspective composite view of a turnbuckle having one jaw in accordance with the invention.

FIG. 3 is an exploded assembly view of the turnbuckle of FIG. 2.

### DESCRIPTION OF THE INVENTION

Reference will now be made in detail to preferred embodiments of the present invention, examples of which are illustrated in the accompanying drawings. Wherever possible, the same reference numbers will be used throughout the drawings to refer to the same or like parts.

The present invention is an improved turnbuckle design having a more robust and reliable toggle jaw with absolutely no sharp edges or protrusions to chaff or tear sails or rigging. The turnbuckle is stronger and much more reliable than conventional designs.

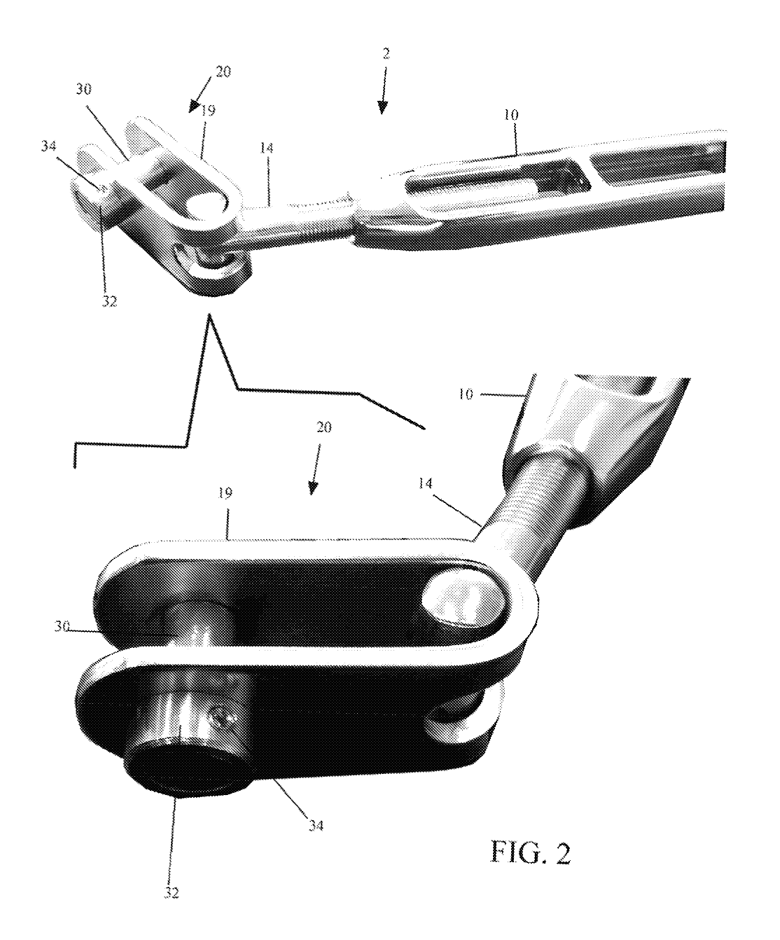

FIG. 2 is a perspective composite view of a turnbuckle 2 having one jaw 20 in accordance with the invention. Turnbuckle 2 generally comprises an elongate stainless steel barrel 10 having two ends, with counter-threaded apertures entering the two ends. Opposing stud-mounted fixtures are threaded into the ends of the barrel 10, one with a left-hand thread and the other with a right-hand thread. FIG. 2 shows one T-style fixture 14 threaded along its distal length at one end and terminating at the other end at a T-style cross-bar. As is well-known, tension is adjusted by rotating the barrel 10, which causes the T-style fixture 14 to extend or contract into barrel 10. A toggle jaw 16 is mounted on the T-style fixture 14, and in the illustrated embodiment the toggle jaw 16 comprises a yoke 19 pivotally mounted on the T-style fixture 14. The yoke 19 is a flat plate member bent in a U-shape cross-section and defined by a central slot therein for passing the T-style fixture 14. The U-shaped yoke 19 rides on the T-style fixture 14 and allows a limited degree of pivoting. The U-shaped yoke 19 extends to a pair of opposing flanges which bear coaxial through-bores for insertion of a clevis pin 17.

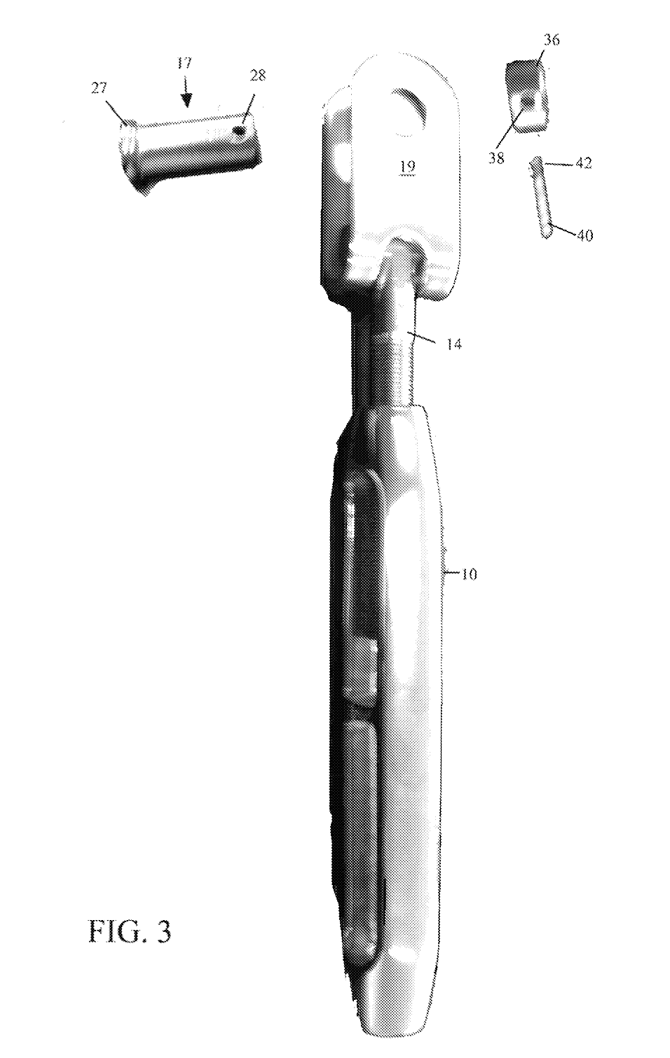

As best seen in the assembly drawing of FIG. 3, the clevis pin 17 comprises a smooth cylindrical member of uniform diameter along its length with a pronounced head 27 at one end, the head 27 being of greater diameter than the majority of the clevis pin 17. The pronounced head 27 forms a disk-like flange to limit insertion of the clevis pin 17 through the flanges of U-shaped yoke 19, and the circular edges of head 27 are beveled smooth to eliminate chaffing. The diameter of clevis pin 17 conforms to the diameter of the through-bores in U-shaped yoke 19 to facilitate sliding insertion, the head 27 being larger to limit insertion, and the length of the clevis pin 17 is such to allow a section of its opposing end to protrude outward past the far flange of U-shaped yoke 19. An orthogonal through bore 28 is formed through the protruding section of the clevis pin 17. An annular collar 36 is fitted overtop the protruding section of clevis pin 17 and serves both as a bearing shoulder against the abutting flange of U-shaped yoke 19, and also as a retainer to prevent extraction of the clevis pin 17. An through bore 38 is formed diametrically through both walls of the collar 36, the through bore 38 being of identical diameter to that of the orthogonal through bore 28 in clevis pin 17 so as to permit insertion of a retaining pin 40 entirely through the collar 36 and clevis pin 17. The through bore 38 in collar 36 is internally screw-threaded through one wall of the collar 36 but not the other. The length of retaining pin 40 exactly conforms to the outer diameter of the collar 36 so that once inserted there is no protrusion. In addition, the retaining pin 40 is screw-threaded at one end (but not the other) so as to anchor it inside the threaded bore 38 in collar 36. Both collar 36 and the head of clevis pin 17 seat flush against the flanges of yoke 19 and the beveled edges of collar 36 and the head of clevis pin 17 prevent abrasion of the rigging or sails. Moreover, the retaining pin 40 seats flush within the collar 36 and completely eliminates rubbing or tearing of lines or sails as commonly occurs with a cotter pin or the like. In addition, the retaining pin 40 is buttressed against shear forces by the surrounding collar 36, resulting in a stronger and more reliable junction than conventional designs.

It should now be apparent that the above-described turnbuckle design is more aesthetically pleasing, has absolutely no damaging sharp edges or protrusions, and yet is stronger and more reliable than conventional designs.

Those skilled in the art will understand that various modifications and variations can be made in the present invention without departing from the spirit or scope of the invention. For example, the above-described invention is equally effective in the context of a spreader stay, head stay, or back stay, which together with the turnbuckle described herein are collectively referred to as “couplings.”

It is to be understood, therefore, that the invention may be practiced otherwise than as specifically set forth in the appended claims.

### STATEMENT OF INDUSTRIAL APPLICABILITY

Turnbuckles are prevalent in sailboat rigging but are also commonly used in any applications which require tension, including flight control systems, sports rigging (boxing rings and the like) and entertainment (stage) rigging. However, turnbuckles typically employ cotter pins which tend to have sharp or abrasive tips/edges. Sails and shrouds tend to rub against the rigging hardware, and rubbing of lines or sails against sharp objects or sharp edges of turnbuckles can result in abrasive chafe or wear of the lines, sails and/or standing rigging. The cotter pins are notorious for tearing sails. There would be great industrial applicability in a turnbuckle that has absolutely no sharp edges or protrusions, and yet is strong or stronger than conventional designs.

What is claimed is:

1. A turnbuckle, comprising:
an elongate barrel having two ends, with counter-threaded apertures entering the two ends;
a T-shaped stud threaded at one end and having a cross-bar at the other end, said threaded end being screw-threaded into an end of the barrel;
a toggle jaw mounted on the T-shaped stud, said toggle jaw comprising,
a yoke formed from a flat plate member bent in a U-shape cross-section and defined by a central slot therein, the cross-bar of said T-shaped stud being seated in the U of said U-shaped yoke with the threaded end of said T-shaped stud passing through said central slot, and said U-shaped yoke extending to a pair of opposing flanges both defined by coaxial through-bores,
a clevis pin inserted through the coaxial through-bores of the opposing flanges of said yoke, said clevis pin comprising a smooth cylindrical member of uniform diameter along a majority of its length and having a pronounced circular head at one end, said clevis pin having a length that allows a section of an opposing end to protrude outward through the flange of said yoke, said clevis pin having an orthogonal through bore formed through the protruding section,
an annular collar fitted overtop the protruding section of clevis pin as both a bearing shoulder and retainer for the clevis pin, said collar having a through bore formed diametrically through both walls, said through bore being internally threaded inside one of said walls, and
a retaining pin inserted through both the collar and clevis pin, the retaining pin being screw-threaded at one end for anchoring it in the threaded through bore of said annular collar;
whereby said retaining pin seats flush within the collar and completely eliminates rubbing or tearing of lines or sails.

2. A coupling, comprising:
an elongate barrel having two ends, with counter-threaded apertures entering the two ends;
a T-shaped stud threaded at one end and having a cross-bar at the other end, said threaded end being screw-threaded into an end of the barrel;
a toggle jaw mounted on the T-shaped stud, said toggle jaw comprising,
a yoke formed from a flat plate member bent in a U-shape cross-section and defined by a central slot therein, the cross-bar of said T-shaped stud being seated in the U of said U-shaped yoke with the threaded end of said T-shaped stud passing through said central slot, and said U-shaped yoke extending to a pair of opposing flanges both defined by coaxial through-bores,
a clevis pin inserted through the coaxial through-bores of the opposing flanges of said yoke, said clevis pin comprising a smooth cylindrical member of uniform diameter along a majority of its length and having a pronounced circular head at one end, said clevis pin having a length that allows a section of an opposing end to protrude outward through the flange of said yoke, said clevis pin having an orthogonal through bore formed through the protruding section,
an annular collar fitted overtop the protruding section of clevis pin as both a bearing shoulder and retainer for the clevis pin, said collar having a through bore formed diametrically through both walls, said through bore being internally threaded inside one of said walls, and
a retaining pin inserted through both the collar and clevis pin, the retaining pin being screw-threaded at one end for anchoring it in the threaded through bore of said annular collar;
whereby said retaining pin seats flush within the collar and completely eliminates rubbing or tearing of lines or sails.
